(19) United States
(12) Patent Application Publication
(10) Pub. No.: US 2005/0091816 A1
(43) Pub. Date: May 5, 2005

(54) Wallpaper seam repair tool

(76) Inventor: Filip Pesek, Bernardsville, NJ (US)

Correspondence Address: PHARMACEUTICAL PATENT ATTORNEYS, LLC, 55 MADISON AVENUE, 4TH FLOOR, MORRISTOWN, NJ, 07960-7397, US

(21) Appl. No.: 10/700,117

(22) Filed: Nov. 4, 2003

(51) Int. Cl. B25B 27/00; B23P 6/00

(52) U.S. Cl. 29/402.18; 29/270

(57) ABSTRACT

A tool for repairing ruptured wallpaper seams, including a hot air blower and a paper press.

### RELATED APPLICATIONS

None.

### GOVERNMENT INTEREST

None.

### BACKGROUND

I am a housepainter and wallpaper hanger. I have noticed in my work that wallpaper is conventionally hung in strips. The wallpaper strips meet at their edges, these edges defining seams between the wallpaper strips. When initially installed, the edges of each wallpaper strip are glued to the wall with adhesive; with the edges firmly affixed to the wall, the seam is aesthetically attractive.

Over time, however, wallpaper paste (the most widely used wallpaper adhesive) ages and can lose its adhesive strength; thus, I have seen the edges of wallpaper strips separating from the wall, leaving the edge of the wallpaper strip hanging free and thus creating an aesthetically unattractive seam. For lack of a better word, I call these “ruptured” seams.

As common as this problem is, fixing a ruptured wallpaper seam is problematic, in large part because the wallpaper to be repaired is not planar. That is, new wallpaper is planar—it lies flat. In contrast, ruptured wallpaper is wallpaper to which wet wallpaper paste has been applied; ruptured wallpaper typically assumes a curled conformation.

People have tried to simply tape the loose wallpaper back in place using cellophane tape; while easy and fast, the adhesive used in cellophane tape will discolor most wallpapers and the cellophane tape will itself discolor to a dark amber over time. This approach thus makes the ruptured seam less attractive than it had been before.

Another approach has been to reapply wallpaper paste adhesive to the unattached piece of wallpaper. This is the conventional approach; painting supply stores currently sell small tubes of wallpaper paste specifically for this purpose. This approach is superior to the cellophane tape approach because it avoids the discoloration caused by the adhesive used on cellophane tape. This approach is difficult to execute in practice, however, because wallpaper paste is not particularly sticky when wet; to the contrary, it obtains its adhesive power only after substantially drying out. Because ruptured wallpaper has a curled conformation, merely putting wet wallpaper paste on it, and pressing the wallpaper in place, will usually result in the wallpaper simply flipping away from the wall again.

What the art needs, what the art has sought unsuccessfully, is a way to fix ruptured wallpaper seams.

I have found a way. I have invented a new tool for fixing ruptured wallpaper seams. The tool is basically a hot air gun with a roller or squeegee attached to the business end. It is useable with any appropriate wallpaper adhesive; the wallpaper paste is applied to the ruptured seam, and then the roller or squeegee presses the wet wallpaper back in place while the hot air gun blows hot air on the wet paste. The hot air makes the wallpaper paste adhere quickly, preventing the ruptured wallpaper from springing away from the wall.

### BRIEF DESCRIPTION OF THE DRAWINGS

FIG. 1 shows an isometric view of an embodiment of my invention mounted on a hot air gun, where the compress is a roller.

FIG. 2 shows a front view (looking from the exhaust end to the input end of the air channel) of the embodiment illustrated in FIG. 1, where the embodiment is mountable on a hot air gun but is not presently mounted.

FIG. 3 shows a rear view of the embodiment illustrated in FIG. 2, looking from the input end to the exhaust end of the air channel.

FIG. 4 shows a left side view, and

FIG. 5 a right side view, of the embodiment illustrated in FIG. 2.

FIG. 6 shows a top view, and

FIG. 7 a bottom side view, of the embodiment illustrated in FIG. 2.

FIG. 8 shows an isometric view of an embodiment of my invention mounted on a hot air gun, where the compress is a flange.

FIG. 9 shows a front view (looking from the exhaust end to the input end of the air channel) of the embodiment illustrated in FIG. 8, where the embodiment is mountable on a hot air gun but is not presently mounted.

FIG. 10 shows a rear view of the embodiment illustrated in FIG. 8, looking from the input end to the exhaust end of the air channel.

FIG. 11 shows a left side view, and

FIG. 12 a right side view, of the embodiment illustrated in FIG. 8.

FIG. 13 shows a top view, and

FIG. 14 a bottom side view, of the embodiment illustrated in FIG. 8.

FIG. 15 shows an isometric view of an embodiment of my invention made integral to a hot air gun, where the compress is a flange.

### DETAILED DESCRIPTION

My invention has several components; I discuss each in turn, referring to the Figures where necessary.

The Adhesive

Wallpaper adhesives are widely known; the most widely known one is conventionally referred to as “wallpaper paste.” I prefer to use this, as it is inexpensive, widely available, and chemically inert against most commercially-available wallpapers.

Other adhesives may, however, be used. For example, thee are a variety of polymeric adhesives which may be attractive for one application or the other. For example, SHUR-STIK™ brand border & vinyl over vinyl adhesive (catalog no. 760), commercially available from The Gibson-Homans Company, Twinsburg, Ohio, is useful for adhering vinyl wallpaper to a non-porous vinyl surface (e.g., for adhering vinyl wallpaper trim over vinyl wallpaper). Similarly, SHUR-STIK™ brand borheavy-duty clear strippable wallcovering adhesive (catalog no. 785), commercially available from The Gibson-Homans Company, Twinsburg, Ohio, is “formulated to hang all types of wallcoverings from lightweight papers to heavyweight vinyls.”

Similarly, PROFESSIONAL® PRO-838′ heavy duty clear wallcovering adhesive, is commercially available from Roman Adhesives, Inc., Calumet City, Calif. The label for the latter product notes that it has “extended open-time” and “high wet tack”; this indicates that this adhesive is specifically formulated to not dry quickly. This is advantageous in hanging new wallpaper, as it allows time for the paperhanger to change the arrangement of the wallpaper strips, but for repairing ruptured wallpaper, extended open time impairs the function of the adhesive. The same manufacturer also sells STICK-EASE® wallcovering seam repair all-purpose touch-up adhesive. The label directions say, “Apply STICK-EASE well under edges to be secured. Press or roll down edges. Wipe off excess immediately with a moist cloth.” I have used this product according to these directions, and find that by following these directions, the adhesive does not work, because ruptured wallpaper is curled and the wet adhesive cannot adhere the curled wallpaper to the wall surface.

The only limitation on the adhesive is that is preferably be neither flammable nor toxic when heated by hot air. I thus, refer to wallpaper adhesive to include both wallpaper paste and other suitable adhesives.

The Air Blower

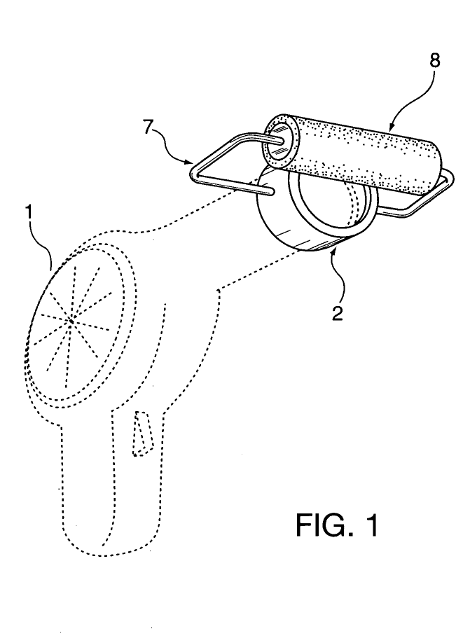

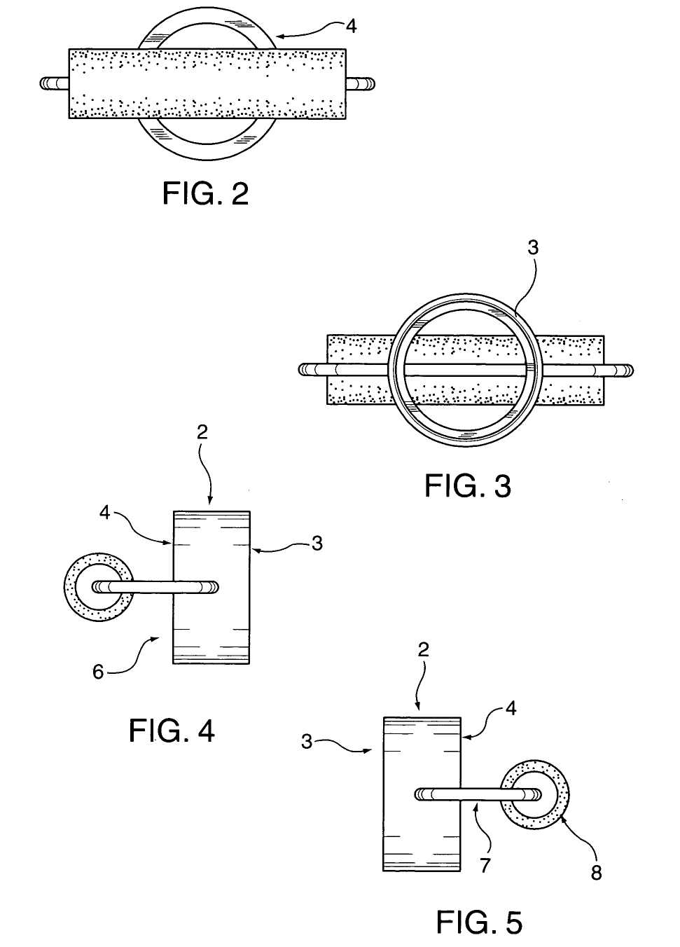

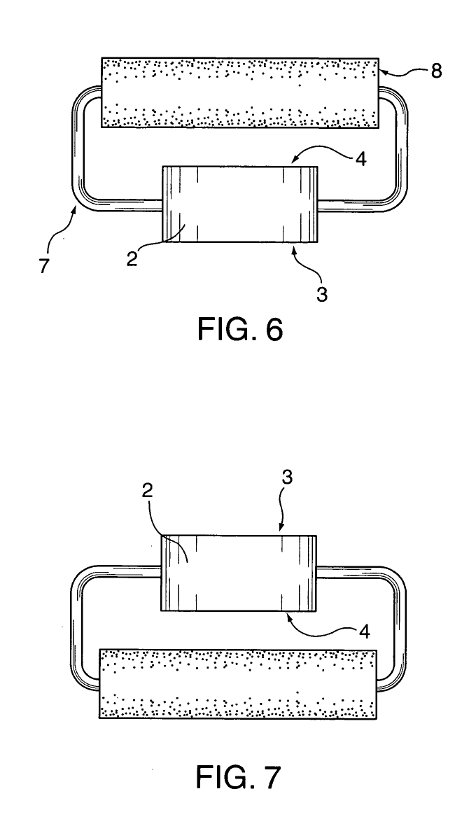

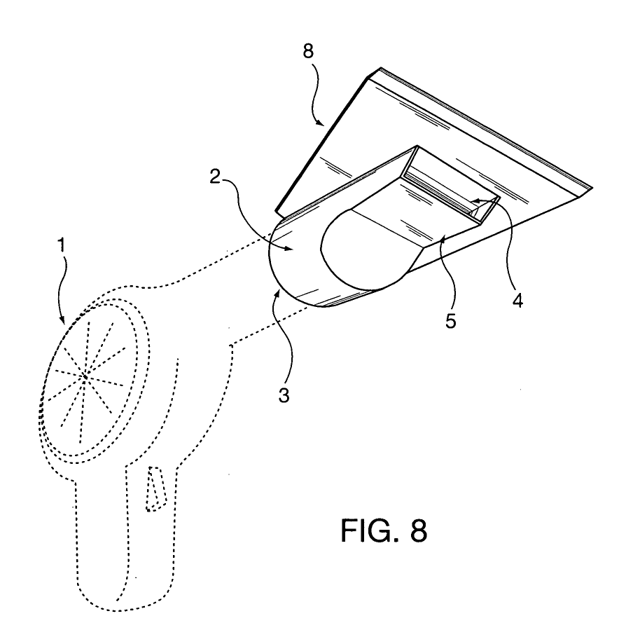

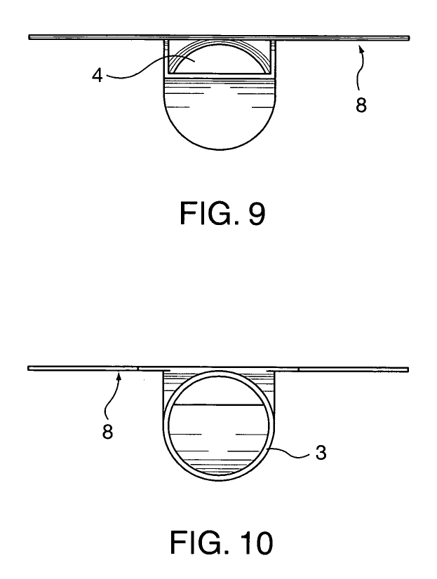

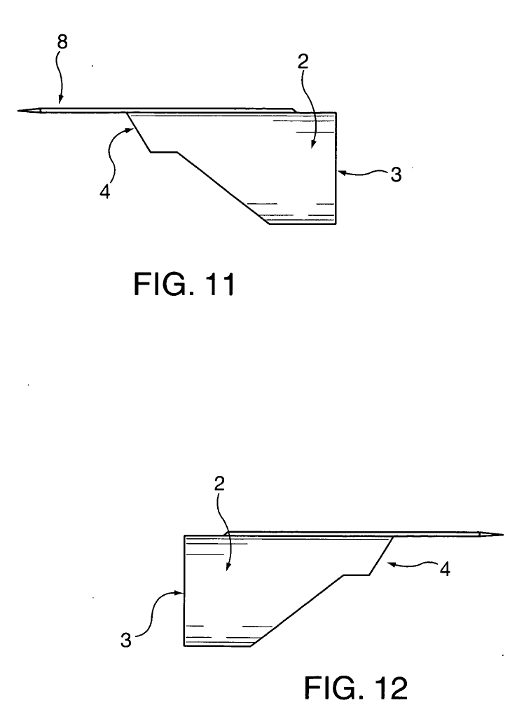

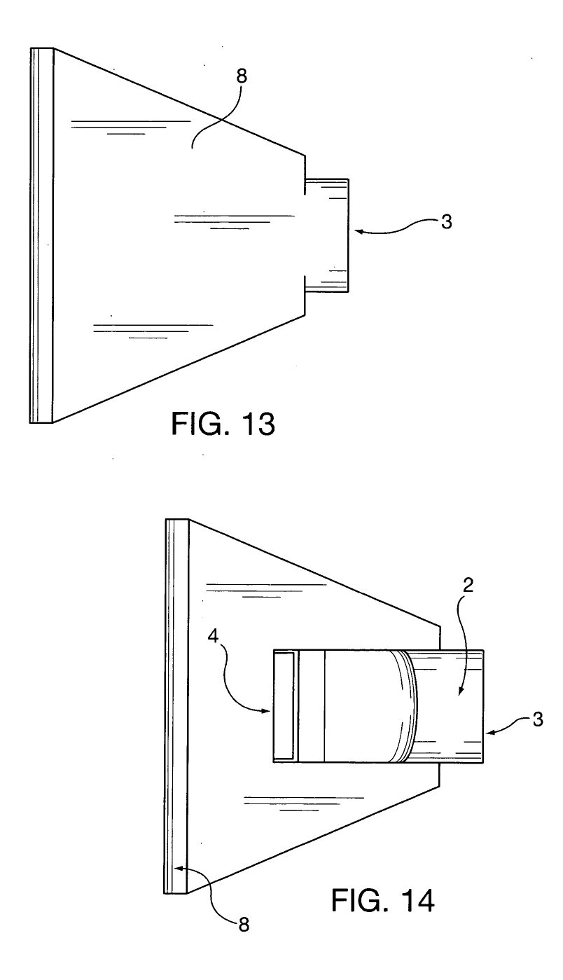

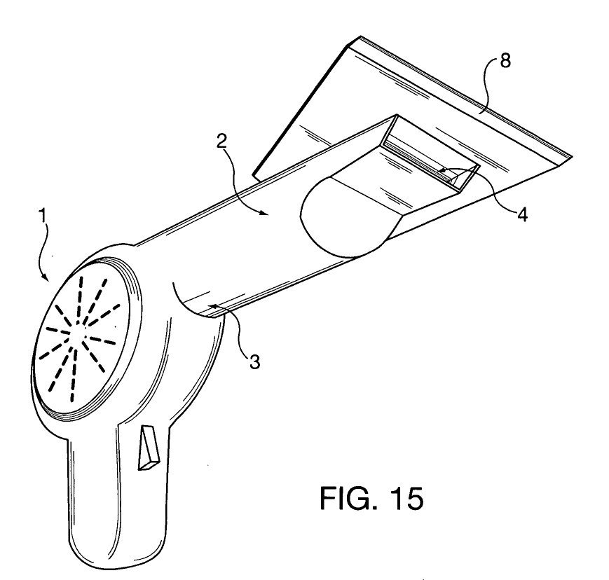

Hot air guns [1] are widely known; hair driers are one example, and painters use similar devices—albeit devices which generate much higher temperatures—to melt and strip old paint while refinishing. It is conceivable to make my device using a custom-made or dedicated hot air generator [see FIG. 15] used only for repairing ruptured wallpaper seams. I prefer, however, to use a standard, commercially available hot air gun [see FIGS. 1, 8] for my device; this enables the user to use the hot air gun not only for repairing ruptured wallpaper seams, but also for alternative uses (e.g., drying hair, stripping paint). I refer to a device which generates and blows hot air as a “hot air blower,” regardless of whether the device is configured as a hot air gun [1] or as some other configuration.

Note that my invention uses a hot air gun [1], but it is possible to make a commercial embodiment of my invention which lacks the air gun, and simply has the air channel—compress structures described below. This is convenient because most house painters have a hot air gun [1] already, and thus would only need a fitting to adapt their hot air gun to this use.

The Air Channel

Connectable to the hot air blower is an air channel [2]. This can be simply a short section of pipe; the pipe may be metal or, if heat-tolerant of the hot air temperature, polyvinyl chloride.

The air channel has two ends—an input end [3] and an exhaust end [4]: hot air enters at the input end [3], and exits at the exhaust end [4]. The air channel input end [3] should be dimensioned to be connectable or connected to the hot air blower [1]. I prefer the air channel input end (3] to have an interior diameter sized to snugly accept the exterior diameter of the air gun used (as shown in the accompanying FIGS. 1 and 8). Alternatively, the air channel input end [3] could as be dimensioned to fit within the interior diameter of the air gun barrel, etc. . . .

If one wants to make an air channel input end [3] adaptable to various air guns with varying barrel diameters, the air channel input end [3] can be made with a tapered interior diameter, so that the taper provides varying interior diameter sizes to accommodate varying air gun barrel external diameters.

The air channel also has an exhaust end [4]. The exhaust end [4] may be configured with, for example a nozzle [5], to direct the appropriate amount of hot air to the appropriate place. This configuration is a design choice which depends on the temperature of the hot air used, the distance between the exhaust end and the wallpaper, and the humidity of the adhesive used.

Alternatively, the exhaust end [4] may simply be a straight-cut [6] pipe end.

The Compress

Connected to the exhaust end of the air channel is a “compress.” I use the term “compress,” for lack of a better word, to denote something that presses the ruptured wallpaper onto the wall, while hot air is applied and the adhesive cures.

I prefer the compress to be a roller holder [7] with a roller [8] attached (see FIG. 1 et seq.). The roller holder [7] may be sized to accept a standard paint roller; in so doing, the end-user can use a paint roller they already have, as part of my invention. It is thus possible to make a version of my invention with simply the roller holder [7], and lacking the roller—leaving the end-user to affix their own paint roller and use it. At this time, however, I prefer a shorter roller [8] because a shorter roller [8] enables the user to apply the same amount of pressure to a smaller surface area (thus more pressure per unit of area) and because a longer roller may lose surface contact along part of its length due to curving or buckling in the wall.

Similarly, it is possible to make my invention with a different size roller: again, simply a design choice.

Similarly, I illustrate the roller holder [7] as two metal armatures extending from the air channel [2]. It is, however, possible to make the roller holder [7] by integrally molding a roller holding means into the body of the air channel [2] itself. This is simply a choice of design.

Similarly, it is possible to make the compress from a squeegee (see FIG. 8 et seq.) or similar flange-shaped piece [8]. Plastic flange shaped pieces useful as, e.g., drywall compound applicator, painting trim guide, painting shield, and wallpaper smoothing device are known in the art and commercially available as, for example, the Hyde Manufacturing Company smoothing tool, catalog no. 45807. I do not prefer this, because it could scratch the surfacing of flocked wallpaper, but it is possible, mechanically simple, and within the scope of my invention. If the flange were shaped with a slight curve (somewhat like the slat of an aluminum Venetian blind), then the flange could in fact pass over the wallpaper flocking without damaging it.

Using My Invention

I will now outline my preferred way to use the preferred version of my invention.

I prefer the end-user first apply wallpaper paste to the ruptured wallpaper seam. This works best where the wallpaper paste is applied not just to the wall, but directly to the wallpaper. This is because the wallpaper paste moistens and softens the wallpaper, making it more malleable.

The end-user then takes the air-gun [1] with the air channel [2]/roller [7, 8] attachment (the end-user having first mounted a roller [8] on the roller holder [7], if necessary) and blows hot air on the wallpaper pasted area, while rolling the roller along the ruptured seam. The wallpaper paste will begin to dry and become tacky. How fast this happens depends on the humidity of the wallpaper paste, the ambient humidity, and the temperature of the hot air used.

The end-user continues to roll along the seam until the wallpaper paste dries enough to become adhesive and the wallpaper thus stays in place flat against the wall.

### SUMMARY

I thus have invented a wallpaper repair article of manufacture comprising an air channel having an exhaust end and an intake end, the exhaust end connected to a compress, said compress positioned to extend from the exhaust end axially along the flow of the hot air; the intake end dimensioned to be connectable to a hot air blower; and, connected to said intake end, a hot air blower. A variation on this is wherein the compress comprises a roller mount which is able to mount a substantially-cylindrical roller rotatably˜that is, so that the cylinder can be rolled or rotated about its axis.

Another variation is wherein the roller mount is sized or dimensioned to fit and mount a substantially cylindrical roller which is approximately the size of a conventional paint roller (approximately length by diameter).

Another variation is where the compress comprises a flange, such as a flat piece of aluminum, perhaps curved at the edge like an aluminum Venetian blind. Another variation is a wallpaper repair kit which includes both the aforementioned fitting for the end of the hot air gun and a container of wallpaper paste. Another aspect of my invention is the method of repairing ruptured wallpaper seams by (i) applying wallpaper paste or another adhesive to the ruptured wallpaper seam; and then (ii) blowing hot air on the before said adhesive is set (i.e., while the wallpaper paste is still wet); and (iii) compressing the seam with a compress.

An equivalent is where the user uses a conventional hot air gun and a conventional wallpaper seam roller, blowing the air with the gun and rolling the seam with the seam roller; while this method performs the same function in the same way to produce the same result as a unitary tool, a unitary tool is more convenient because it requires only one hand to execute it.

While I have discussed and illustrate various versions or embodiments here, it would be straightforward for one to develop variations on my idea. Thus, I intend that the coverage of my patent be defined not by the specific illustrations and examples I discuss, but by the legal claims which follow.

In the claims, I use the term “a” to allow for more than one (i.e., the singular means “at least one”).

1. A wallpaper repair article of manufacture comprising:
A. An air channel having an exhaust end and an intake end, such that hot air blown into the intake end exhausts out the exhaust end of the air channel;
B. Said exhaust end connected to a compress, said compress positioned to extend from the exhaust end axially along the flow of the hot air;
C. Said intake end dimensioned to be connectable to a hot air blower; and
D. Connected to said intake end, a hot air blower.

2. The article of manufacture of claim 1, wherein said compress comprises a roller mount able to rotatably mount a substantially-cylindrical roller.

3. The article of manufacture of claim 2, wherein said roller mount is dimensioned to mount a substantially cylindrical roller approximately the size of a paint roller.

4. The article of manufacture of claim 1, wherein said compress comprises a flange.

5. A wallpaper repair kit comprising:
(i) a wallpaper repair article of manufacture comprising
A. An air channel having an exhaust end and an intake end, such that hot air blown into the intake end exhausts out the exhaust end of the air channel;
B. Said exhaust end connected to a compress, said compress positioned to extend from the exhaust end axially along the flow of the hot air; and
C. Said intake end dimensioned to be connectable to a hot air blower; and
(ii) wallpaper adhesive.

6. The article of manufacture of claim 5, wherein said compress comprises a roller mount able to rotatably mount a substantially-cylindrical roller.

7. The article of manufacture of claim 6, wherein said roller mount is dimensioned to mount a substantially cylindrical roller approximately the size of a paint roller.

8. The article of manufacture of claim 5, wherein said compress comprises a flange.

9. A wallpaper seam repair method comprising:
(i) Applying adhesive to said wallpaper seam; and then
(ii) blowing hot air from a hot air blower on said seam, and before said adhesive is set,
(iii) compressing said seam with a compress.

10. The method of claim 9, wherein said compress comprises a roller mount able to rotatably mount a substantially-cylindrical roller.

11. The method of claim 10, wherein said roller mount is dimensioned to mount a substantially cylindrical roller approximately the size of a paint roller.

12. The method of claim 9, wherein said compress comprises a flange.
